(19) United States
(12) Patent Application Publication
(10) Pub. No.: US 2009/0081095 A1
(43) Pub. Date: Mar. 26, 2009

(54) Process for Destroying Carbonaceous Materials and Composition and System Thereof

(75) Inventor: James A. Wasas, Point Pleasant Beach, NJ (US)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(73) Assignee: Cotwocon, Inc., Monmouth Junction, NJ (US)

(21) Appl. No.: 12/234,228

(22) Filed: Sep. 19, 2008

Related U.S. Application Data
(60) Provisional application No. 60/994,574, filed on Sep. 20, 2007.

(51) Int. Cl. B01D 53/62; B01D 53/46; C02F 1/58

(52) U.S. Cl. 423/220; 423/210; 210/749; 422/168

(57) ABSTRACT

A process for substantially removing carbonaceous material from a composition comprising providing the composition having carbonaceous material, reacting the carbonaceous material with a sulfur compound, and forming products having carbon and sulfuric acid, sulfurous acid and/or sulfur dioxide, and the resulting composition and system used therefore.

### CROSS-REFERENCE TO RELATED APPLICATIONS

This application claims the benefit of priority to U.S. Provisional Patent Application Ser. No. 60/994,574 filed on Sep. 20, 2007, the contents of which are incorporated in this application by reference.

### BACKGROUND OF THE INVENTION

The invention relates to destroying carbonaceous materials in compositions. Particular applicability can be found in removing carbon dioxide from gas and liquid compositions.

It is often desirable to remove carbonaceous materials from a composition or the atmosphere. For example, carbon sequestration is a process that removes carbon dioxide from the atmosphere. To help mitigate global warming, a variety of methods of capturing and storing carbon, as well as of enhancing natural sequestration processes, have been explored.

The Claus Process is currently known in the art as a standard of the industry for converting hydrogen sulfide into sulfur. Hydrogen sulfide occurs naturally in natural gas and is referred to as “sour gas” when the hydrogen sulfide concentration is high and is also produced while refining petroleum or other industrial processes. In the Claus Process, just enough of the hydrogen sulfide is oxidized with air or oxygen into sulfur dioxide to react with the balance of the hydrogen sulfide and produce elemental sulfur and water. Part of this process is accomplished at temperatures above 850° C. and part is accomplished in the presence of catalysts, such as activated alumina or titanium dioxide.

The chemical reactions of the Claus Process are:

2H₂S+3O₂→2SO₂+2H₂O; and

4H₂S+2SO₂→3S₂+4H₂O.

In addition, carbonyl sulfide may be produced by the following chemical reaction:

CO₂+H₂S →COS+H₂O.

See A. Attar, Fuel 57, 201 (1978); R. Steudel, Z Anorg. Allg. Chem. 346, 255 (1966).

### SUMMARY OF THE INVENTION

One aspect of the invention provides a process for substantially removing carbonaceous material from a composition comprising providing the composition having carbonaceous material; reacting the carbonaceous material with a sulfur compound; and forming products having sulfuric acid and/or sulfurous acid and/or sulfur dioxide and a carbon-containing compound.

Another aspect of the invention provides a composition substantially free of carbonaceous material, the carbonaceous material removed by a process comprising providing a chemical composition, having carbonaceous material, and a sulfur compound; and causing the carbonaceous material to contact the sulfur compound.

A further aspect of the invention provides a system for substantially removing carbonaceous material from a composition comprising a reactor for receiving the composition, having carbonaceous material, and a sulfur compound and producing products substantially free of the carbonaceous material.

### DETAILED DESCRIPTION OF THE INVENTION

The invention provides a method of substantially removing carbonaceous material from a composition. The carbonaceous material is preferably carbon dioxide. Carbon dioxide may be a liquid or a gas.

The composition may be any composition having carbonaceous material, but is, preferably, a liquid or gas. The carbonaceous material may exist in fossil fuels and other burning fuels, atmospheric gases, organic matter, elements of the earth and other sources, such as cement kilns and asphalt plants. One example of the composition is carbon dioxide, which may be produced by a power plant burning fossil fuel.

The carbonaceous material is substantially removed, or destroyed, by providing the composition having carbonaceous material, reacting the carbonaceous material with a sulfur compound, and forming products having carbon and sulfur. “Substantially” means at least 50% removal, but removal may be as much as 100%. Preferably, at least 70%, more preferably, at least 85%, and most preferably, at least 95% of the carbonaceous material is removed following contact with the sulfur compound. The extent of removal depends upon how much carbonaceous material contacts the sulfur compound, i.e., 100% contact=100% destruction, 95% contact=95% destruction, and no contact=no destruction.

The reactants include the carbonaceous material, the sulfur compound, and optionally, an oxide or hydroxide. The carbonaceous material is preferably carbon dioxide and the sulfur compound is preferably hydrogen sulfide. In the preferred embodiment, the proportion of reactants are in the range of about 2:1 to 3:2 molar volume of carbon dioxide to molar volume of hydrogen sulfide. The reactants may also incorporate one or more oxides or hydroxides and may be any oxide or hydroxide that drives the reaction to completion more rapidly than if no oxide or hydroxide is present. Exemplary oxides and hydroxides include calcium oxide, calcium hydroxide and sodium hydroxide. Catalysts may be also employed to accelerate the rate of chemical reaction. Exemplary catalysts are vanadium pentoxide and titanium dioxide.

The reaction occurs when the carbonaceous material contacts the sulfur compound and may be accelerated by various catalysts and operating conditions, such as elevated pressures and temperatures. The carbonaceous material and the sulfur compound may be injected into a reactor that has, preferably, an oxygen-free atmosphere, where the oxygen content is minimized. Hydrogen sulfide may preferentially react with any oxygen present to produce sulfur dioxide if the atmosphere contains any oxygen, i.e., the preference of hydrogen sulfide is to react with oxygen, rather than carbon dioxide, so the presence of oxygen may be wasteful of the hydrogen sulfide. However, it is to be understood that trace amounts of oxygen may remain unreacted with hydrogen sulfide, and for the purposes of this invention, the term “oxygen-free” as used herein may also mean between 0.01% oxygen to 0.00% oxygen. The contents of the reactor may be excited to accelerate the rate of reaction by electromagnetic radiation, sparking or heating to up to 1,000° C.

The reaction may occur at a temperature of about room temperature to 1,000° C. Typically, higher temperatures drive the reaction to the production of COS, moderate temperatures in the range of 125 to 500° C. drive the production of H₂SO₄, H₂SO₃, SO₂, H₂O, C and S and/or carsuls, and lower temperatures favor the production of H₂O, C and S or H₂O and carsuls. Temperatures above room temperature accelerate the reaction. The reactor may also be pressurized at or above atmospheric pressure to accelerate the reaction. Pressurization is particularly preferred in reactions involving hydrogen sulfide gas.

The reactants may be fed on a continuous basis into a reactor. Preferably, for laboratory use, the reactor is a batch reactor and, preferably, for industrial use, the reactor is a continuous tubular reactor. Before the reactor is charged with the reactants, it may be sealed and purged with inert gas, such as argon or nitrogen.

The products from the reaction include a carbon-containing compound, such as carbon, including elemental carbon, and carbon-sulfur polymers and any of sulfuric acid, sulfur dioxide, water, sulfurous acid, sulfur, sulfites and sulfates. The carbon may be amorphous or structured. The carbon-sulfur polymers may be simple as in the case of carbon disulfide (CS₂) or complex with structures, such as (CSₚ)ₘ, where p is from 0.2 to about 50, and m is a numerical value greater than or equal to 2, and preferably greater than 10. This compound may also contain other elements, such as, but not limited to, hydrogen and oxygen. These carbon-sulfur polymers are sometimes referred to as carsuls, which are usually black compounds having a melting point of over 500° C. and comprise sulfur and carbon as their primary components.

In one embodiment, the carbonaceous material is carbon dioxide, the sulfur compound is hydrogen sulfide, and the products are sulfuric acid and carbon and/or carbon-sulfur polymers. This embodiment may be represented by the following chemical reaction:

2CO₂+H₂S→H₂SO₄+2X,

where X is carbon and/or a carbon sulfur polymer.

In another embodiment, the carbonaceous material is carbon dioxide, the sulfur compound is hydrogen sulfide, and the products are sulfurous acid and carbon and/or carbon-sulfur polymers. This embodiment may be represented by the following chemical reaction:

3CO₂+2H₂S→2H₂SO₃+3X,

where X is carbon and/or a carbon sulfur polymer.

In another embodiment, the carbonaceous material is carbon dioxide, the sulfur compound is hydrogen sulfide, and the products are sulfur dioxide, water, and carbon and/or carbon-sulfur polymers. This embodiment may be represented by the following chemical reaction:

3CO₂+2H₂S→2H₂O+2SO₂+3X,

where X is carbon and/or a carbon sulfur polymer.

In another embodiment, the carbonaceous material is carbon dioxide, the sulfur compound is hydrogen sulfide, and the products are sulfate, water and carbon and/or carbon-sulfur polymers. This embodiment may be represented by the following chemical reaction:

2CO₂+H₂S+Y→Z+nH₂O+2X,

where: Y is an oxide or hydroxide;

Z is a sulfate which may incorporate the nH₂O into its structure as a hydrated sulfate;

n is 1 or 2; and

X is carbon and/or a carbon-sulfur polymer.

During this reaction, the carbonaceous material and the sulfur compound react with the oxide or hydroxide to form a hydrated sulfate. Exemplary chemical reactions of this embodiment include:

2CO₂+H₂S+CaO→CaSO₄.H₂O+2X;

2CO₂+H₂S+Ca(OH)₂→CaSO₄.2H₂O+2X;

2CO₂+H₂S+NaOH→NaHSO₄.H₂O+2X; and

2CO₂+H₂S+2NaOH→Na₂SO₄+2X+2H₂O (existing as a mixture of Na₂SO₄ with Na₂SO₄.7H₂O and/or Na₂SO₄.10H₂O),

where X is carbon and/or a carbon-sulfur polymer.

In another embodiment, the carbonaceous material is carbon dioxide, the sulfur compound is hydrogen sulfide, and the products are sulfite, water and carbon and/or carbon-sulfur polymers.

This embodiment may be represented by the following chemical reaction:

3CO₂+2H₂S+2Y→2Z+nH₂O+3X,

where: Y is an oxide or hydroxide;

Z is a sulfite which may incorporate the nH₂O into its structure as a hydrated sulfite;

n is 2 or 4; and

X is carbon and/or a carbon-sulfur polymer.

During this reaction, the carbonaceous material and the sulfur compound react with the oxide or hydroxide to form a hydrated sulfite. Exemplary chemical reactions of this embodiment include:

3CO₂+2H₂S+2CaO→2CaSO₃+2H₂O+3X;

3CO₂+2H₂S+2Ca(OH)₂→2CaSO₃+4H₂O+3X; and

3CO₂+2H₂S+2NaOH→2NaHSO₃+2H₂O+3X,

where X is carbon and/or a carbon-sulfur polymer. The products may be separated after they are formed. The products may be discharged and any solids, liquids and gases may be separated. The products may then be cooled.

Excess carbon dioxide may be provided into the reactor. Preferably, any excess amount ranges from 1 to 50%, but more or less may be used if required by the application. As such, any unreacted carbon dioxide will be easily separated as unreacted gas.

The process, which destroys carbon dioxide and other carbonaceous materials by rearranging their atomic components, simultaneously creates new carbon molecules.

These carbon molecules are amorphous or are structured, and may also be carbon-sulfur polymers. The structured carbon molecules are of various types with various physical properties, and include, but are not limited to, carbon black, graphitic carbon, diamond-like carbon and nanotube-like structured carbon. Under controlled conditions, such as seeding desired species, carbon nanotubes, for example, may be created and/or grown. Carbon-sulfur polymers may be used for manufacture of carbon fiber-like products or other uses.

The invention also provides a composition substantially free of carbonaceous material, where the carbonaceous material is removed by the above-described process and a system for substantially removing carbonaceous material from the composition. The system requires a reactor. On a small scale, a batch-type reaction may be performed in a single or multi-necked glass flask, where the necks are fitted with adapters for the addition of reactants and exit of products. The reactor may be made of temperature-resistant borosilicate glass or quartz glass, such as that supplied by Pyrex®, Kimble® Glass, United Glass Technologies and Buchi® Corporation. High pressure reactions may be conducted in reactors constructed specifically for such reactions, such as manufactured by Parr Instrument Company. Temperature may be measured by a thermometer through glass contact, or by other means, such as non-contact laser guided infrared readings, and product gases may be cooled with a Vigreux column or by other means. In one embodiment, the Vigreux column is mounted above the reactor, or flask, to serve as a condenser.

On a large scale, the reactor may be a packed tower type reactor, or any other of the numerous types commonly used for contacting reactants. These reactors may be glass lined reactors. The equipment is not limited to that described in the application. Any equipment may be used as long as it performs the steps of the process.

A benefit of the process if used in a power plant includes the destruction of carbon dioxide (to maintain carbon neutrality or toward maintaining carbon neutrality) and the production of commercial products, including sulfuric acid, sulfurous acid, sulfur dioxide, carbon and/or carsuls and possibly various sulfates or sulfites. The produced carbon may be used for, but is not limited to, providing carbon to carbon fiber manufacturers and other users of carbon. If carbon-sulfur polymers, or carsuls, exist in the products, these may be sold for use in carbon fiber-like applications, among others.

One embodiment of the process includes the following steps:

(a) injecting carbon dioxide and hydrogen sulfide into a reactor in an oxygen-free atmosphere at up to 1,000° C. in the proportions of two molar volumes of carbon dioxide to one molar volume of hydrogen sulfide to react and form sulfuric acid and a carbon-containing compound; and

(b) separating the products of this reaction.

The chemical reaction may be: 2CO₂+H₂S→H₂SO₄+2C. Alternatively, the chemical reaction may be: 2CO₂+H₂S→2H₂O+carbon-sulfur polymer.

One benefit of this embodiment is having less stringent operating parameters than if using the Claus Process. Other benefits include the destruction of carbon dioxide toward or for carbon neutrality and the production of carbon, carbon-sulfur polymer and sulfuric acid. Among other benefits, by way of example and not intending to be limiting, the products may be transported for purposes, including, but not limited to, the sale of the products. As an additional benefit, the separation of the products of hydrogen sulfide from natural gas would be unnecessary when the gas is destined for combustion in power plants that are equipped to use this embodiment, thereby making the gas less expensive. A power plant may benefit from lower fuel costs by burning impure crude or unrefined gas and may produce extra energy from burning the hydrogen sulfide in an exothermic reaction.

The following examples are presented to illustrate the process, system and composition of the invention. These examples are intended to aid those skilled in the art in understanding the present invention. The present invention is, however, in no way limited thereby.

The chemical reaction between carbon dioxide and hydrogen sulfide designed to produce sulfuric acid may take place at room temperature or above by mixing the two gases and compressing them. Catalysts, such as vanadium pentoxide and titanium dioxide, accelerate the reaction, as does elevated temperatures.

This embodiment may be industrially implemented in ways that include, but are not limited to, natural gas-burning power plants. These plants that employ the invention could use higher sulfur content gas instead of a more expensive, low sulfur content gas. Preferably, a lean oxygen burn would be used to minimize excess oxygen. By feeding hot effluent gases of mixed carbon dioxide and sulfur dioxide (with or without other components of air, such as nitrogen, if air were the oxidizer) into a Claus or tower type reactor (pressurization greatly accelerates the reaction velocity) with hydrogen sulfide being fed on a continuous basis, the hot carbon dioxide reacts with the hydrogen sulfide. The discharge from the reactor is sulfuric acid and/or sulfurous acid and carbon, and/or carbon-sulfur polymers and other components of air, such as nitrogen, if air is the oxidizer in the power plant. Separating the products from the discharge gases may be accomplished with a conventional gravity separator and bag house technology.

While the invention has been described in detail and with reference to specific embodiments thereof, it will be apparent to one skilled in the art that various changes and modifications can be made therein without departing from the spirit and scope thereof. Thus, it is intended that the invention covers the modifications and variations of this invention provided they come within the scope of the appended claims and their equivalents.

1. A process for substantially removing carbonaceous material from a composition comprising:
providing the composition having carbonaceous material;
reacting the carbonaceous material with a sulfur compound; and
forming products having at least one of a sulfuric acid, sulfurous acid, and sulfur dioxide and a carbon-containing compound.

2. The process of claim 1 wherein the carbonaceous material comprises carbon dioxide.

3. The process of claim 1 wherein the sulfur compound comprises hydrogen sulfide.

4. The process of claim 1 wherein the products comprise at least one of carbon, carbon-sulfur polymer, sulfuric acid, sulfurous acid, sulfur dioxide, water, sulfite and sulfate.

5. The process of claim 1 wherein the products comprise at least one of carbon and carbon-sulfur polymer.

6. The process of claim 1 further comprising providing at least one of an oxide and hydroxide.

7. The process of claim 1 wherein the reacting comprises feeding the composition into a reactor having a pressure from approximately atmospheric pressure to above atmospheric pressure.

8. The process of claim 1 wherein the reacting comprises providing a reactor having an oxygen-free atmosphere.

9. The process of claim 1 wherein the reacting comprises:
injecting the carbonaceous material and the sulfur compound as contents into a reactor in an oxygen-free atmosphere; and
at least one of exciting and catalyzing the contents to accelerate a rate of reaction.

10. The process of claim 1 wherein the reacting comprises providing a proportion of molar volumes of carbon dioxide to molar volume of hydrogen sulfide in a range from about 2:1 to 3:2.

11. The process of claim 1 wherein the reacting comprises providing excess carbon dioxide.

12. The process of claim 1 further comprising separating the products from the composition.

13. The process of claim 1 further comprising providing a reactor having a temperature of about room temperature to 1,000° C.

14. The process of claim 1 wherein the carbonaceous material comprises carbon dioxide, the sulfur compound comprises hydrogen sulfide, and the products comprise at least one of elemental carbon, water, carbon-sulfur polymer, sulfurous acid, sulfuric acid, and sulfur dioxide.

15. The process of claim 1 wherein the carbonaceous material is completely removed from the composition.

16. The process of claim 1 wherein at least 95% of the carbonaceous material is removed from the composition.

17. A composition produced from the process of claim 1.

18. A composition substantially free of carbonaceous material, the carbonaceous material removed by a process comprising:
providing a chemical composition, having carbonaceous material and a sulfur compound with a ratio of two molar volumes of carbonaceous material to one molar volume of sulfur compound; and
causing the carbonaceous material to contact the sulfur compound.

19. The composition of claim 18 wherein the carbonaceous material comprises carbon dioxide.

20. The composition of claim 18 wherein the sulfur compound comprises hydrogen sulfide.

21. The composition of claim 18 wherein the process further comprises producing products of at least one of carbon, water, carbon-sulfur polymer, sulfuric acid, sulfurous acid, and sulfur dioxide.

22. A system for substantially removing carbonaceous material from a composition comprising a reactor for receiving the composition, having carbonaceous material and a sulfur compound with a ratio of molar volumes of carbonaceous material to molar volume of sulfur compound of about 2:1 to 3:2, and producing products substantially free of the carbonaceous material.

23. The system of claim 22 wherein the carbonaceous material comprises carbon dioxide.

24. The system of claim 22 wherein the sulfur compound comprises hydrogen sulfide.

25. The system of claim 22 wherein the products comprise at least one of carbon, water, carbon-sulfur polymer, sulfuric acid, sulfurous acid, and sulfur dioxide.
